(19) United States
(12) Patent Application Publication
(10) Pub. No.: US 2004/0143468 A1
(43) Pub. Date: Jul. 22, 2004

(54) Boat club and method of operating same

(76) Inventor: Mark A. Bilawsky, Boynton Beach, FL (US)

Correspondence Address: PROSKAUER ROSE LLP, PATENT DEPARTMENT, 1585 BROADWAY, NEW YORK, NY, 10036-8299, US

(21) Appl. No.: 10/696,593

(22) Filed: Oct. 28, 2003

Related U.S. Application Data
(60) Provisional application No. 60/422,376, filed on Oct. 29, 2002.

(51) Int. Cl. G06F 17/60

(52) U.S. Cl. 705/7

(57) ABSTRACT

A boating club is administered offering limited memberships to pre-qualified individuals enabling members to obtain the benefits of boat ownership without the need to incur high investment costs, high operating costs, and without the need to invest significant amounts of time to accomplish the tasks commonly associated with boat ownership. This is accomplished via an organization established to provide boats and a complete array of services to the member, thus substantially eliminating the member's involvement in any phase of boat ownership other than the actual use of the boat. A fleet of distinctive boats will be utilized thereby offering to the member access to a caliber of boats that might not otherwise be available. Members pay a fixed annual fee, which may be billed monthly, in exchange for which they are entitled to use of the boat of their choice on a flexible schedule over the course of the year. Since the member uses the same boat each time, the experience is as close to owning your own boat without actually doing so.

### RELATED APPLICATION

This application claims the benefit of U.S. provisional application Ser. No. 60/422,376 entitled “BOAT CLUB AND METHOD OF OPERATING SAME,” filed on Oct. 29, 2002 for Mark A. Bilawsky. The contents of this provisional application are fully incorporated herein by reference.

### FIELD OF THE INVENTION

The invention relates to the operation of a boat club that enables a wide range of individuals to avail themselves of the pleasures of boating while minimizing the overall cost and investment of time and money required for owning and maintaining the boats.

### BACKGROUND OF THE INVENTION

Boat ownership offers those who can afford it the privilege of enjoying boating at the owner's leisure. However, the high cost of boat ownership, including the purchase price, and maintenance and insurance costs, especially of high caliber boats, has discouraged many from purchasing boats and has caused many former boat owners to refrain from purchasing new boats.

In lieu of boat ownership, people have long been able to rent boats from boat rental companies, typically on a daily basis, or on some other basis, such as for a weekend, weekly, monthly, etc.. Boats available for rental tend to be old, in poor condition and, yet, costly to rent. Additionally, the boats generally available for daily rentals are smaller in size and offer few, if any, amenities (e.g., technically-advanced features or optional luxury features) that are offered in larger, newer and more expensive models of boats.

Boating enthusiasts can also gain access to boats by joining so-called boat membership “clubs,” which claim to offer boaters the benefits of ownership without the related costs or other negative aspects of boat ownership, such as responsibility for maintenance and repair and for winter storage. The members pay an annual fee for the right to rent one of the club's boats that is available on a particular day at what is described as a “members' daily rate.” Like boat rental companies, these “clubs” also generally offer lower quality boats and few, if any, amenities on the boats. The club memberships come at a high cost. These existing clubs also typically have large numbers of members, which makes boat availability a problem. Perhaps most significantly, these clubs do not have what many boaters would consider adequate insurance. Most of these clubs offer limited, if any, comprehensive general liability insurance, and charge extra fees for property damage coverage.

Another type of program available is the traditional time-share arrangement. In such an arrangement, a small group of individuals form a group, such as a partnership, for the purpose of purchasing a boat. Typically, the boat is extremely expensive, thus requiring a large up-front cash investment from each participant. Additionally, some type of management company is required to manage the partnership. The fees charged by the management company further increases the cost of ownership. There may also be high operating costs, which must be apportioned equitably among the partners. Structuring a boat purchase as a time share partnership thus requires a substantial commitment on the part of each participant. It can also be difficult to extricate oneself from participation in the partnership because the individual's undivided interest must be transferred to another person.

It is therefore apparent that there exists a significant need in the art for a new type of business entity and method for operating this business entity which enables an individual to enjoy the pleasures of boating.

### SUMMARY OF THE INVENTION

It is therefore an object of this invention to provide a different type of membership club that enables club members to enjoy the pleasures and benefits of owning a boat without the need to invest large sums of capital.

Another object of this invention is to make more costly and luxurious boats available to individuals who would not otherwise have the means to obtain such boats.

Another object of this invention is to provide a system for maintaining the physical operating condition of the boat without the intervention of the club member.

Another object of this invention is to provide a club from which an individual can extract himself/herself from participation without sustaining significant financial loss, such as loss associated with rapid, substantial depreciation in value of a boat.

These and other objectives of the invention are accomplished by providing a boat club established and operated in accordance with the present invention. The club is established by a club operator that purchases a fleet of boats, which are preferably new and loaded with amenities. The club owns and operates the boats, including paying for maintenance, service and repair, and for insurance. The club offers memberships that may require an up-front initiation fee and annual renewal fees. The memberships may be offered to individuals or business entities.

Club members are given the right to exclusively use a particular one of the boats in the club's fleet for a fixed number of days during each respective member's membership year. The fixed number of days will typically be 20 days per member per membership year. Members who desire to use the selected boat or a different one of the boats for additional days must purchase one or more additional memberships, each providing the member with another fixed number of days, meaning typically another 20 days/membership.

A single boat in the club's fleet can only be selected by a limited number of members per membership year. At the beginning of the membership year, each member specifies the particular boat from the fleet that he desires to use. The member will be granted the right to use the boat so long as the membership roster for that boat is not full. The particulars of the selected boat, such as the size, and amenities of the selected boat, and the number of days reserved by the club member are generally taken into account in pricing the annual fee to be charged to the member.

The club's membership may change each year with some new members joining the club and others not renewing their membership. Additionally, the allocation of boats to the members can change each year. Some members who selected one boat during a first year may request a different boat for the following year.

As a result of the invention, a member can obtain, at reasonable cost, the many benefits available to individuals owning their own boats without any of the significant negative elements commonly associated with boat ownership.

### BRIEF DESCRIPTION OF THE DRAWINGS

The following detailed description, given by way of example and not intended to limit the present invention solely thereto, will best be understood in conjunction with the accompanying drawings, in which:

FIG. 1A depicts a representation of a membership club established in accordance with an embodiment of the invention and the relationship between the club and its members in Year 1;

FIG. 1B depicts a representation of a membership club established in accordance with the embodiment of FIG. 1A and the relationship between the club and its members in Year 2;

FIG. 1C depicts a representation of a membership club established in accordance with the embodiment of FIG. 1A and the relationship between the club and its members in Year 5;

FIG. 2A depict a representation of a membership club established in accordance with the embodiment of FIG. 1A and the allocation of club boats to club members in Year 1;

FIG. 2B depicts a representation of a membership club established in accordance with the embodiment of FIG. 1A and the allocation of club boats to club members in Year 2;

FIG. 2C depicts a representation of a membership club established in accordance with the embodiment of FIG. 1A and the allocation of club boats to club members in Year 5; and

FIG. 3 depicts a computer on which membership, boat allocation, and boat usage information is tracked.

### DETAILED DESCRIPTION OF THE PREFERRED EMBODIMENT

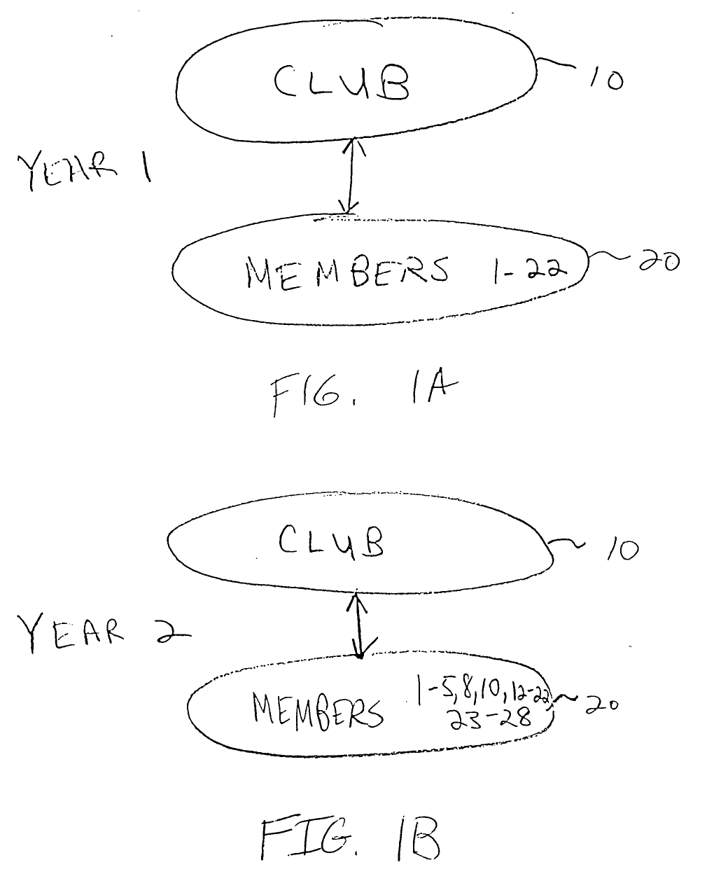

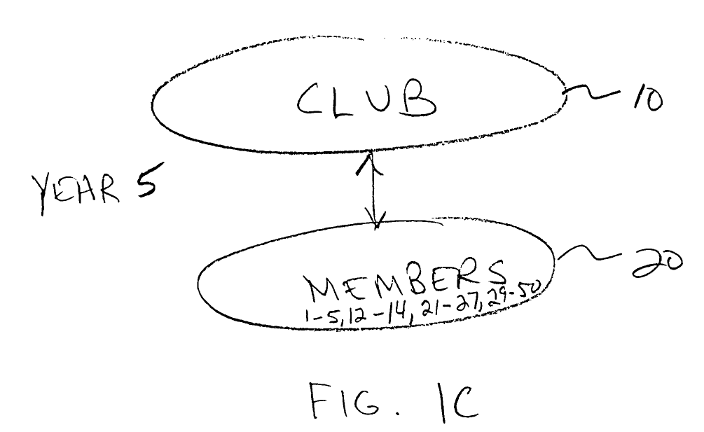

Referring to FIG. 1A, a membership organization or club 10 is formed for the purpose of acquiring a fleet of distinctive, high-end boats, to be made available to its members 20. The club operators assume the responsibility and associated costs and burdens of purchasing, maintaining and insuring the boats, including any financing thereof. Thus, the club's responsibilities includes all services related to the operation of the boat, including dockage, routine/special maintenance needs, boat preparation and clean up before and after use. The member is relieved of all responsibility for maintenance of any kind.

The club also secures appropriate and adequate levels of insurance covering both property damage and personal liability protection for the boat, the member and his/her guests, as well as coverage for property damage and personal liability protection for the property of and/or injury to third parties. Moreover, it is the responsibility of the club to assure that the boat is properly registered and in full compliance with all governmental regulations and requirements, including those related to maintaining proper safety equipment and systems aboard all boats.

The club charges a membership fee for individuals or others to join as club members. This may include a one-time, up-front initiation/administration fee, plus an annual fee, which will be based on the boat selected for use. For convenience, the annual fee may be payable on a monthly basis via a direct credit card charge to the members account. The membership fees entitle each club member to a membership term that is typically for one year and can be renewed annually.

The club offers its paid-up members a fixed number of days each year to enjoy a selected one of the club's boats. The selection of which boat a particular member will use is made by the member at the beginning of the membership year based on boat availability. For each boat, there will be a membership roster that has a limited maximum number of members that can sign up to use the boat during a membership year.

Each member thus selects which of the club's available boats he or she wishes to use during the membership term. The member will be granted the use of the selected boat for the fixed number of days granted to a member if the membership roster for the selected boat is not yet fill. A member will only have use of the selected boat for the fixed number of days during his respective membership year. As one alternative, the roster for one boat may be filled before beginning to fill another boat's roster. In another alternative, the club fills the rosters for its available boats by request, although this may lead to a situation where, during a particular membership year, one or more boats have less than full rosters.

As stated, each club membership entitles a member to use a selected one of the club's boat for a fixed number of days per membership year. Typically, a single membership will entitle a member to use a boat for 20 days per year. If the member wishes to use this same boat or another boat in the club's fleet for additional days, the member must purchase one or more additional memberships, each entitling the member to an additional set of fixed number of days per year. For example, a second membership entitles the club member to an additional set of 20 days per year to use a selected club boat (which may be either the same boat or a different one of the boats), a third membership entitles the club member to a third set of 20 days per year to use a boat (for a total of 60 days' use), etc.

The total number of members that are permitted to select a particular boat is limited by the club, e.g. 10 members may select a particular boat per year. This desirably limits the overall number of days in the year that the members can select a particular boat to far fewer than 365 days. As a result, where there is a 20 day limit per member each membership year and only 10 members can use the boat per year, a particular boat will be reserved for use for a maximum of 200 days per year. Such a limitation on use is intended to insure that each member gets to use the boat for the full complement of days each year (in this example, 20 days) that he is entitled to under the membership agreement. It also offers a member some flexibility as to when the member can use the boat and allows for days that the boat cannot be used due to inclement weather and/or maintenance requirements.

At the end of each membership year, the member has the ability to request a boat other than the one he currently shares if it is available.

The club replaces the boats at regular, short-term intervals at no additional cost to members. This system thereby assures that members will have access to new, state of the art equipment without the associated risks and uncertainty of residual value issues associated with boat ownership.

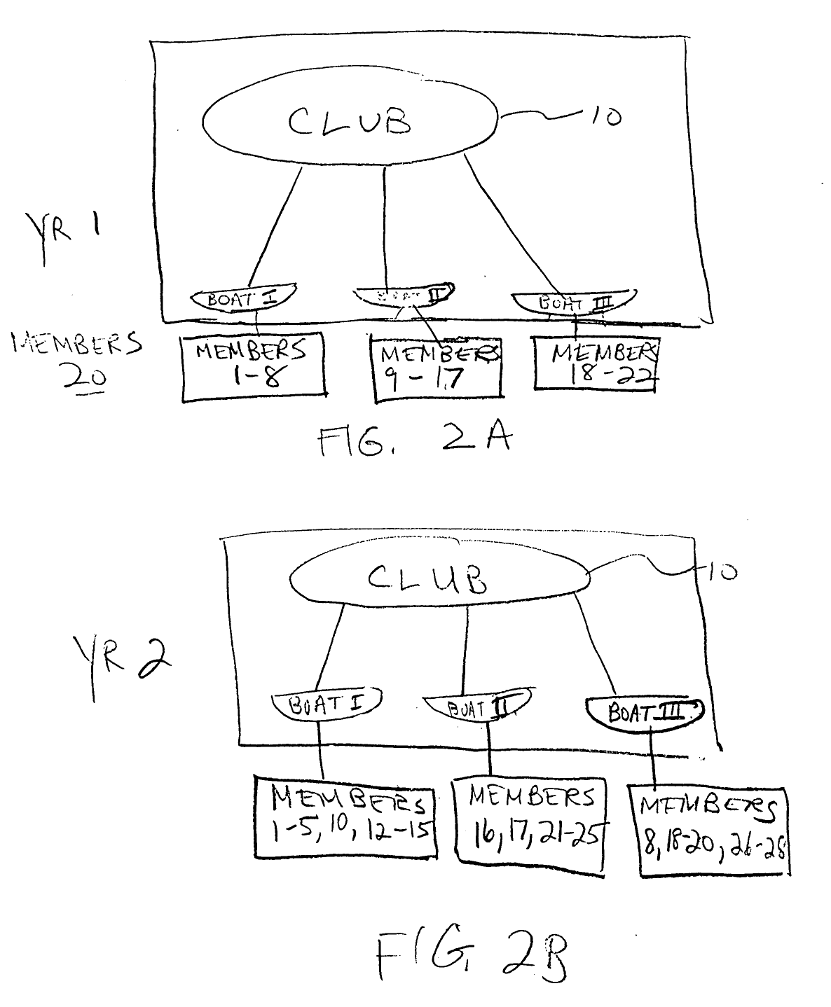

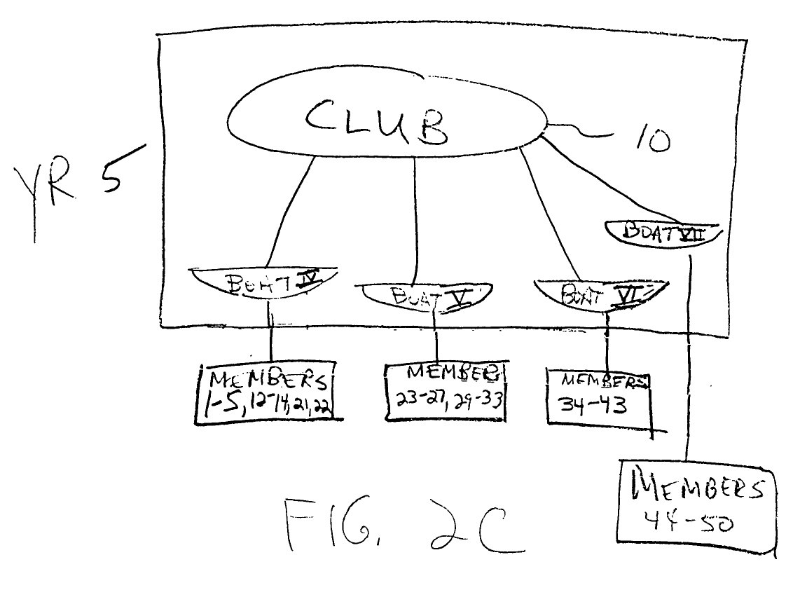

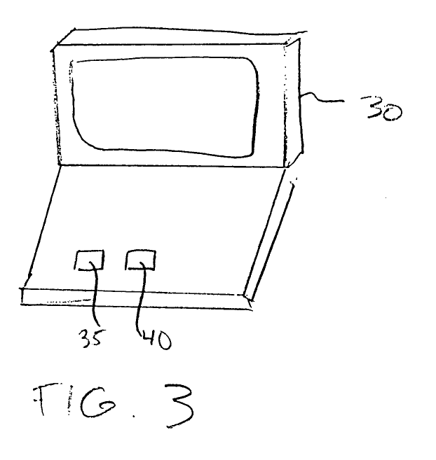

FIGS. 1A through 1C and FIGS. 2A through 2C help illustrate how a membership club established in accordance with the invention operates during hypothetical membership Years 1, 2, and 4. In the example, as depicted in FIG. 1A, members 1-22 join the club in Year 1 when the club is first formed. If there were two fewer members, all of these members could be accommodated in accordance with club policy by purchasing two substantially identical or similar boats with 10 members using each boat. In this case, each member would get to select which of the two boats he wants on a first-come, first-serve basis. Obviously, once one boat is selected by 10 members, the balance of the members can only select the other boat.

Where there are 22 members, however, the club must purchase a third boat. This scenario is illustrated in FIG. 2A. In this case, the 22 members belonging to the club in Year 1 can choose from Boats I-III. Members 1-8 select Boat I for use during Year 1. Each of members 1 through 8 then gets to use Boat I for 20 days during Year 1. Since only eight members have selected Boat I and Boat I is therefore reserved for only 160 days, if one of members 1 through 8 wants to use Boat I for additional days, there are 40 additional days or two more memberships remaining. Members 9-17 select Boat II for Year 1, thereby also leaving two additional memberships available for Boat II. Members 18-22 select to use Boat III for 20 days each, leaving excess capacity for Boat III as well. (Of course, if any of the three boats is a better boat by virtue of having perhaps better features, being larger, etc., then it will likely cost a member a premium for the membership year to use the better boat.)

As depicted in FIG. 1B, in the following year, Year 2, the club's membership is likely to change, with some returning members and new members. For example, of the original members 1-22, members 1-5, 8, 10, and 12-22 return and are joined by new members 23-28. Non-returning members may have decided not to pay the annual fee to renew their memberships, so they are ineligible to use a boat during Year 2 but the club may provide for them to return as active members in future years.

Referring to FIG. 2B, the club members in Year 2 can each select an available one of the three boats, Boats I-III, regardless of the boat selected during Year 1. Members 1-5 again select, for example, Boat I and members 10 and 12-15 also select Boat I. So Boat I is fully booked by a total of 10 members. Members 16 and 17 select Boat II along with members 21-25. Members 8, 18-20 and 26-28 select Boat III.

FIG. 1C illustrates the club membership during Year 5. The club's members now include members 1 through 5, 12 through 14, 21 through 27, and 29 through 50. Since Boats I through III are four years old and the club's membership has expanded, the club replaces Boats I, II and III with new Boats IV, V, VI and VII shown in FIG. 2C. During Year 5, members 1 through 5, 12 through 14, 21 and 22 select Boat IV, members 23 through 27 and 29 through 33 select Boat V, members 34 through 43 select Boat VI, and members 44 through 50 select Boat VII.

FIG. 3 illustrate a computer 30 on which membership, boat allocation, and boat usage records can be stored in computer memory 35. The records can be processed using software resident in memory 35 using processor 40. For example, software can be used to track the number of days each member has paid for to use his boat during the particular membership year, and the number of times the member has used the boat to date during this year. The software can also be provided with a calendar to schedule member reservations for use of the boats.

Although a preferred embodiment is specifically described herein, it will be appreciated that modifications and variations of the present invention are covered by the above teachings and are within the purview of the appended claims without departing from the spirit and intended scope of this invention.

What is claimed is:

1. A method of operating a boat club comprising:
maintaining a plurality of boats for use by members of said boat club;
selling memberships in said boat club covering a membership period designated by said boat club;
wherein memberships are sold by units, each membership unit entitling a member who has purchased said membership unit to a fixed number of days during said membership period that said member may exclusively use a particular one of said boats, said fixed number of days being identical for each of said membership units, and wherein said particular one of said boats to be used during said membership period by said member is to be selected by said member for said membership period; and
limiting the number of said membership units for which said particular one of said boats for said membership period may be selected such that the combined fixed number of days for all of said membership units for which said particular one of said boats is selected is shorter than said membership period.
